(19) United States
(12) Patent Application Publication
(10) Pub. No.: US 2011/0276662 A1
(43) Pub. Date: Nov. 10, 2011

(54) METHOD OF CONSTRUCTING MULTIMEDIA STREAMING FILE FORMAT, AND METHOD AND APPARATUS FOR SERVICING MULTIMEDIA STREAMING USING THE MULTIMEDIA STREAMING FILE FORMAT

(75) Inventors: Yong-gyoo KIM, Hanam-si (KR); Gil-yoon KIM, Suwon-si (KR); Soon-yong JEONG, Suwon-si (KR); Tae-sung PARK, Yongin-si (KR)

(73) Assignee: SAMSUNG ELECTRONICS CO., LTD., Suwon-si (KR)

(21) Appl. No.: 13/102,511

(22) Filed: May 6, 2011

Related U.S. Application Data
(60) Provisional application No. 61/332,276, filed on May 7, 2010.

(30) Foreign Application Priority Data
Jun. 18, 2010 (KR) 10-2010-0058235

(51) Int. Cl. G06F 15/16

(52) U.S. Cl. 709/219

(57) ABSTRACT

A method of constructing a multimedia streaming file format, and a method and apparatus for servicing multimedia streaming using the multimedia streaming file format, the method of constructing the multimedia streaming file format including the operations of arranging a plurality of mdat boxes that store multimedia data, and a moof box that stores metadata related to the multimedia data stored in the plurality of mdat boxes; and generating a fragment using the plurality of mdat boxes that store the multimedia data, and using the moof box that stores the metadata related to the multimedia data stored in the plurality of mdat boxes, wherein the plurality of mdat boxes are positioned ahead of the moof box.

### CROSS-REFERENCE TO RELATED PATENT APPLICATIONS

This application claims priority from U.S. Provisional Application No. 61/332,276, filed on May 7, 2010, in the U.S. Patent and Trademark Office, and Korean Patent Application No. 10-2010-0058235, filed on Jun. 18, 2010, in the Korean Intellectual Property Office, the disclosures of which are incorporated herein their entirety by reference.

### BACKGROUND

1. Field

Methods and apparatuses consistent with exemplary embodiments relate to a multimedia streaming service system, and more particularly, to a method of constructing a multimedia streaming file format, and a method and apparatus for servicing multimedia streaming using the multimedia streaming file format, whereby latency in a Hyper Text Transfer Protocol (HTTP)-based live multimedia streaming service is minimized.

2. Description of the Related Art

Recently, a streaming service for transmitting a moving picture via the Internet or a mobile communication network has become widely used.

In general, the streaming service is a multimedia service that plays multimedia data in a user terminal and then removes the multimedia data without storing it. The streaming service is widely used in wired communication networks but it is a more useful service for a mobile communication terminal including a mobile phone that does not have enough storage space to store the multimedia data.

In particular, a Hyper Text Transfer Protocol (HTTP)-based streaming service that is enabled to use existing web infrastructure has become increasingly popular.

In general, fragmented MPEG Audio Layer-4 (fragmented MP4) is used as a file format for live HTTP streaming.

Thus, in an existing live HTTP streaming service, a server and a client exchange data in units of fragments.

That is, it is not possible for the server to know the size of all of the multimedia data to be transmitted, so the multimedia data is divided into fragments in units of several seconds, and then transmitted.

However, in a case where a live HTTP streaming service is performed by using an existing fragmented MP4 file format, the server receives a fragment request and then transmits data in a unit of a fragment. At this time, latency corresponding to a time unit (f seconds) of the fragment occurs. In addition, the client requires a buffering time (b seconds) equal to or greater than a predetermined time period, so as to perform jitter compensation and audio/video synchronization. Thus, a difference of at least (f+b) seconds occurs between a capture time in the server and a rendering time in the client.

### SUMMARY

It is an aspect of exemplary embodiments to provide a multimedia streaming service system, and more particularly, a method of constructing a multimedia streaming file format, and a method and apparatus for servicing multimedia streaming using the multimedia streaming file format, whereby latency in a Hyper Text Transfer Protocol (HTTP)-based live multimedia streaming service is minimized.

According to an aspect of an exemplary embodiment, there is provided a method of constructing a multimedia streaming file format, the method including the operations of arranging a plurality of mdat boxes that store multimedia data, and a moof box that stores metadata related to the multimedia data stored in the plurality of mdat boxes; and generating a fragment using the plurality of mdat boxes that store the multimedia data, and using the moof box that stores the metadata related to the multimedia data stored in the plurality of mdat boxes, wherein the plurality of mdat boxes are positioned ahead of the moof box.

A streaming file may be formatted by adding a ftyp box and a moov box to at least one fragment, wherein the ftyp box describes a type of a content file and the moov box stores the metadata related to the multimedia data.

A minimum unit of each of the plurality of mdat boxes may be a frame unit.

A minimum unit of each of the plurality of mdat boxes may be a slice unit.

A maximum unit of each of the plurality of mdat boxes may be the multimedia data comprising audio/video data in the fragment.

The moof box may include a fragment size box.

According to another aspect of an exemplary embodiment, there is provided a method of servicing multimedia streaming, the method including the operations of receiving a request for multimedia data in a unit of a fragment; dividing and transmitting the multimedia data in units of a plurality of mdat boxes; and after the operation of dividing and transmitting the multimedia data in the units of the plurality of mdat boxes is complete, transmitting a moof box to a client, wherein the moof box includes stored metadata related to the multimedia data stored in the plurality of mdat boxes.

The fragment may include the plurality of mdat boxes, and the moof box comprising the stored metadata related to the multimedia data stored in the plurality of mdat boxes, and the plurality of mdat boxes may be positioned ahead of the moof box.

A minimum unit of each of the plurality of mdat boxes may be a frame unit or a slice unit.

A maximum unit of each of the plurality of mdat boxes may be the multimedia data comprising audio/video data in the fragment.

A frame size box may be added in the moof box and then the moof box may be transmitted.

A first mdat box from among the plurality of mdat boxes may be accessed using the frame size box added in the moof box.

The client may reproduce the multimedia data by the unit of the fragment using the multimedia data that is received in the units of the plurality of mdat boxes, and the moof box that is received after the transmitting of the multimedia data is complete.

The dividing and transmitting the multimedia data may begin prior to receiving all multimedia data corresponding to the fragment.

According to another aspect of an exemplary embodiment, there is provided an apparatus for servicing multimedia streaming, the apparatus including a file multiplexer that generates a fragment using a plurality of mdat boxes that divide and store multimedia data, and a moof box including stored metadata; and a web server that divides and transmits the multimedia data in units of the plurality of mdat boxes when a request for a fragment file is received from a client, and that transmits the moof box including stored metadata when the transmitting of the multimedia data in the units of the plurality of mdat boxes is complete.

The web server may begin to divide and transmit the multimedia data prior to receiving all multimedia data corresponding to the fragment file.

### BRIEF DESCRIPTION OF THE DRAWINGS

The above and other aspects will become more apparent by describing in detail exemplary embodiments with reference to the attached drawings in which:

FIG. 1 is a diagram illustrating a structure of a multimedia streaming file format according to an exemplary embodiment;

FIG. 2 is a block diagram of a multimedia streaming service system according to an exemplary embodiment;

FIG. 3 is a flowchart of signals and data in the multimedia streaming service system according to an exemplary embodiment;

FIG. 4 is a flowchart of signals and data in a multimedia streaming service system according to the related art, compared to the multimedia streaming service system according to an exemplary embodiment;

FIG. 5 is a flowchart of a method of servicing multimedia streaming, according to an exemplary embodiment; and

FIG. 6 is a flowchart of a multimedia streaming processing method performed by a client, according to an exemplary embodiment.

### DETAILED DESCRIPTION OF EXEMPLARY EMBODIMENTS

Hereinafter, exemplary embodiments will be described in detail with reference to the attached drawings.

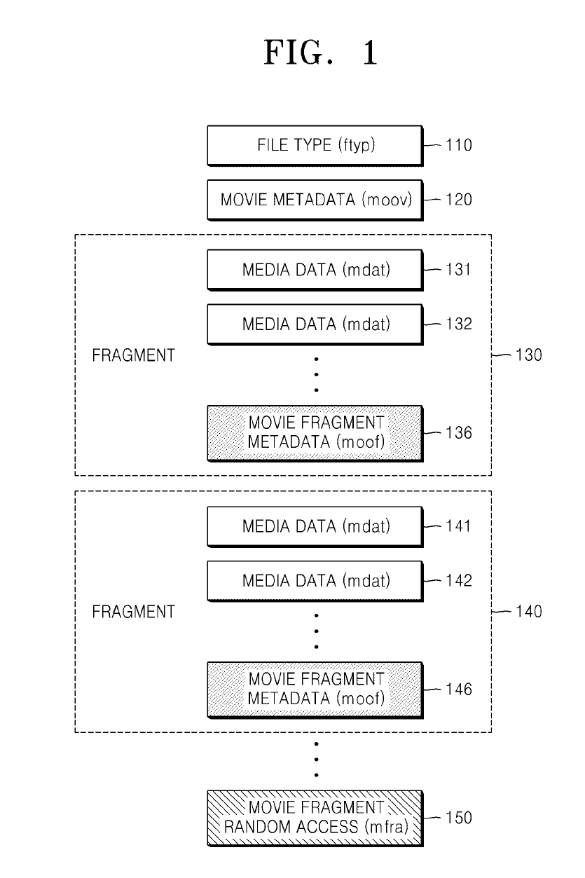

FIG. 1 is a diagram illustrating a structure of a multimedia streaming file format according to an exemplary embodiment.

The multimedia streaming file format of FIG. 1 is formed of a file type (ftyp) box 110, a movie metadata (moov) box 120, a plurality of fragments 130 and 140, and a movie fragment random access (mfra) box 150.

The ftyp box 110 describes a type of a content file.

The moov box 120 describes metadata related to the content file, e.g., a position of image data, a size of the image data, or the like.

The mfra box 150 stores position information related to each fragment.

The fragment 130 includes a plurality of mdat boxes 131 and 132, and a moof box 136, and the fragment 140 includes a plurality of mdat boxes 141 and 142, and a moof box 146. Each of the fragments 130 and 140 includes multimedia data corresponding to several seconds.

The mdat boxes 131 and 132, or the mdat boxes 141 and 142 divide the multimedia data into a plurality of units, and store them.

The moof boxes 136 and 146 record metadata related to the multimedia data stored in the mdat boxes 131 and 132 and the mdat boxes 141 and 142, respectively.

Here, the ftyp box 110, the moov box 120, and the mfra box 150 have the same file format as an existing fragmented MPEG Audio Layer-4 (fragmented MP4) file format.

However, the multimedia streaming file format according to the present embodiment and the existing fragmented MP4 file format are different from each other in terms of elements that constitute the fragment 130 or 140.

The existing fragmented MP4 file format uses a fragment composed of one moof box and one mdat box. The moof box is positioned ahead of the mdat box.

However, the fragment 130 or 140 in the multimedia streaming file format according to the present embodiment includes the mdat boxes 131 and 132 or the mdat boxes 141 and 142 for dividing and storing the multimedia data, and the moof box 136 or 146 for recording the metadata related to the multimedia data that is stored in the mdat boxes 131 and 132 or the mdat boxes 141 and 142. The mdat boxes 131 and 132 or the mdat boxes 141 and 142 are positioned ahead of the moof box 136 or 146.

A minimum unit of a mdat box is a frame unit or a slice unit, and a maximum unit of the mdat box is the whole audio/video data in a fragment.

A fragment size box is added to each of the moof boxes 136 and 146 so as to permit easy access to a first mdat box from among the mdat boxes 131 and 132 or the mdat boxes 141 and 142. Thus, the first mdat box may be accessed by a frame size box added in the each of the moof boxes 136 and 146.

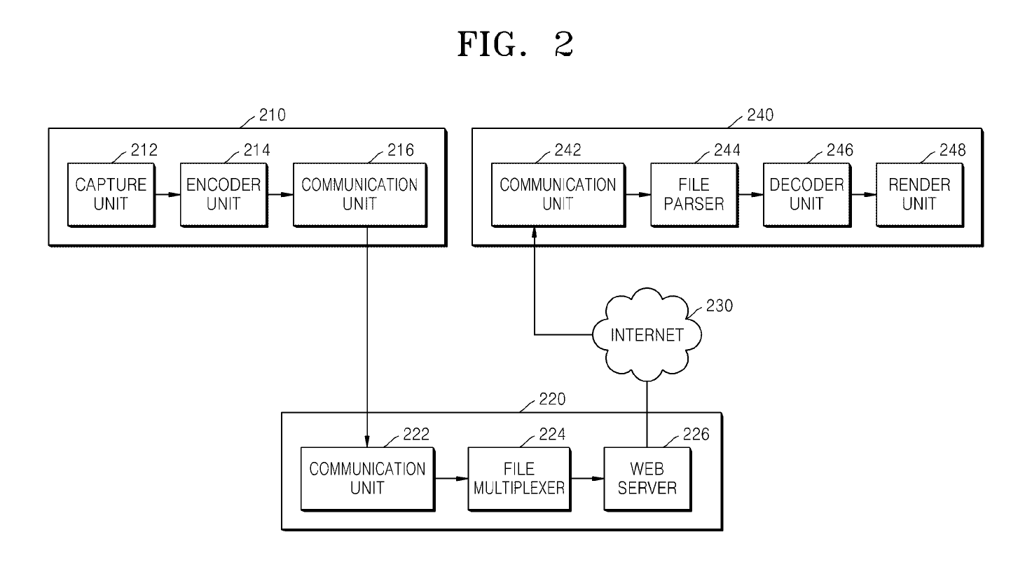

FIG. 2 is a block diagram of a multimedia streaming service system according to an exemplary embodiment.

The multimedia streaming service system of FIG. 2 includes a sender 210 for providing a plurality of pieces of multimedia data, a server 220 for formatting the plurality of pieces of multimedia data in units of fragments and servicing the plurality of pieces of multimedia data, and a client 240 for reproducing the plurality of pieces of multimedia data.

First, the sender 210 is described below.

A capture unit 212 of the sender 210 captures image and audio data using a camera. An encoder unit 214 of the sender 210 compresses the image and audio data, which are captured by the capture unit 212, using a predetermined compression algorithm such as the Moving Picture Experts Group (MPEG) standard.

A communication unit 216 of the sender 210 transforms the image and audio data, which are compressed by the encoder unit 214 according to a predetermined protocol, and transmits the image and audio data to the server 220 via the protocol.

Next, the server 220 is described below.

A communication unit 222 of the server 220 receives the compressed image and audio data from the sender 210.

A file multiplexer 224 of the server 220 multiplexes the compressed image and audio data into the multimedia streaming file format of FIG. 1. That is, the file multiplexer 224 generates the multimedia streaming file format in such a manner that the file multiplexer 224 forms a fragment using a plurality of mdat boxes and a moof box, and adds a ftyp box and a moov box to the fragment, wherein the ftyp box describes a type of a content file and the moov box stores metadata of multimedia data.

A web server 226 of the server 220 receives a manifest file request from the client 240, and then transmits the image and audio data to the client 240 using the multimedia streaming file format of FIG. 1 which is generated by the file multiplexer 224. For example, when the web server 226 receives a fragment file request from the client 240, the web server 226 divides multimedia data in units of a plurality of mdat boxes, and transmits the mdat boxes. When the transmission of the mdat boxes is complete, the web server 226 transmits a moof box including recorded metadata.

Next, the client 240 is described below.

A communication unit 242 of the client 240 receives image and audio data in the multimedia streaming file format from the server 220 via a network such as the Internet 230.

A file parser 244 parses the image and audio from the multimedia streaming file format that is received via the communication unit 242.

A decoder unit 246 of the client 240 decodes the image and audio data, which are parsed by the file parser 244, into image and audio signals.

A render unit 248 of the client 240 performs a rendering operation for displaying the image signal, which is decoded by the decoder unit 246, on a screen.

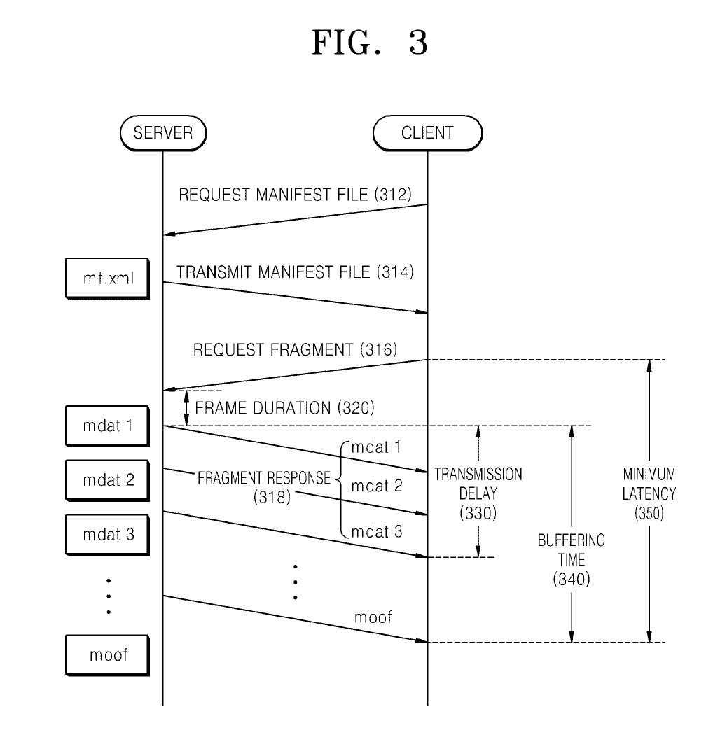

FIG. 3 is a flowchart of signals and data in the multimedia streaming service system according to an exemplary embodiment.

First, the client 240 requests a manifest file from the server 220 (operation 312). The manifest file includes content information such as total content duration, a stream type, a codec, the number of fragments, fragment duration, or the like.

Next, the server 220 transmits the manifest file (mf.xml) to the client 240 (operation 314).

Afterward, the client 240 requests a fragment file from the server 220 (operation 316).

Next, the server 220 requests multimedia data desired by the client 240 from the sender 210, and performs an improved fragment response using the multimedia data received from the sender 210 (operation 318).

That is, the server 220 divides the multimedia data in real time into units of mdat boxes mdat 1, mdat 2, mdat 3, . . . , and transmits the mdat boxes mdat 1, mdat 2, mdat 3, . . . , to the client 240. After the server 220 completes the transmission of the multimedia data, the server 220 transmits a moof box including recorded metadata.

According to the related art, a server requires a fragment duration in which the server generates multimedia data in units of fragments, each formed of one moof box and one mdat box.

However, according to exemplary embodiments, the server 220 does not generate a plurality of pieces of multimedia data in units of fragments but instead divides the multimedia data into units of mdat boxes and transmits the mdat boxes, so that the server 220 requires the frame duration 320.

Finally, the client 240 forms a fragment using the mdat boxes and a moof box received from the server 220, and then reproduces the plurality of pieces of multimedia data in units of fragments. Here, the client 240 requires a buffering time 340 for jitter compensation and audio/video synchronization. Also, the client 240 has a transmission delay 330 of the server 220 which is related to the multimedia data.

Thus, according to exemplary embodiments, it is possible to transmit a part of the multimedia data even before the multimedia data corresponding to one fragment is received, so that latency between the server 220 and the client 240 is minimized.

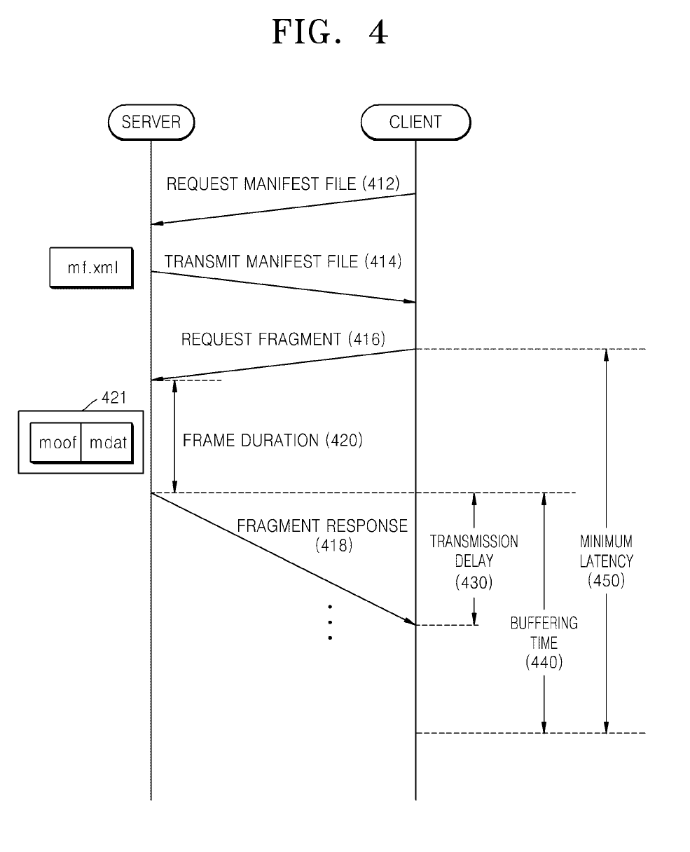

FIG. 4 is a flowchart of signals and data in a multimedia streaming service system according to the related art, compared to the multimedia streaming service system according to an exemplary embodiment.

A manifest file request (operation 412), a manifest file transmission (operation 414), and a fragment request (operation 416) of FIG. 4 are the same as the manifest file request (operation 312), the manifest file transmission (operation 314), and the fragment request (operation 316) of FIG. 3. Also, a transmission delay 430 and a buffering time 440 in a client are the same as the transmission delay 330 and the buffering time 340 of FIG. 3.

However, a fragment response 418 according to the related art is different from the fragment response 318 according to exemplary embodiments. That is, the fragment response 418 according to the related art transmits multimedia data by a unit of a fragment while the fragment response 318 transmits multimedia data by a unit of a mdat box.

A difference between the multimedia streaming service system according to the related art and the multimedia streaming service system according to an exemplary embodiment is compared with reference to FIGS. 3 and 4.

As illustrated in FIG. 4, according to the related art, it is necessary to transmit the multimedia data in a unit of a fragment including one moof box and one mdat box in a fragment duration 420 in which the multimedia data is stored in the unit of the fragment including one moof box and one mdat box.

However, as illustrated in FIG. 3, according to exemplary embodiments, the fragment including one moof box and one mdat box as illustrated in FIG. 3 is not transmitted but instead multimedia data in units of mdat boxes is transmitted and then a moof box is transmitted. Here, exemplary embodiments only require the frame duration 320 in which the multimedia data is stored in the mdat boxes. In other words, according to exemplary embodiments, the client 240 requests multimedia data in a unit of a fragment from the server 220, but the server 220 responds to the request for the multimedia data by the client 240 in a unit of a mdat box.

Accordingly, latency corresponding to frame duration of the mdat box is required in the exemplary embodiment of FIG. 3. However, latency corresponding to fragment duration of the fragment including one moof box and one mdat box is required according to the related art of FIG. 4. Thus, comparing minimum latencies 350 and 450 between the server 220 and the client 240, according to exemplary embodiments and the related art, exemplary embodiments may further minimize latency, compared to the related art.

Also, according to exemplary embodiments, it is not necessary to wait for the fragment duration in which the server 220 generates a fragment, so that the buffering time 340 for jitter compensation and audio/video synchronization generates a minimum latency in the client 240.

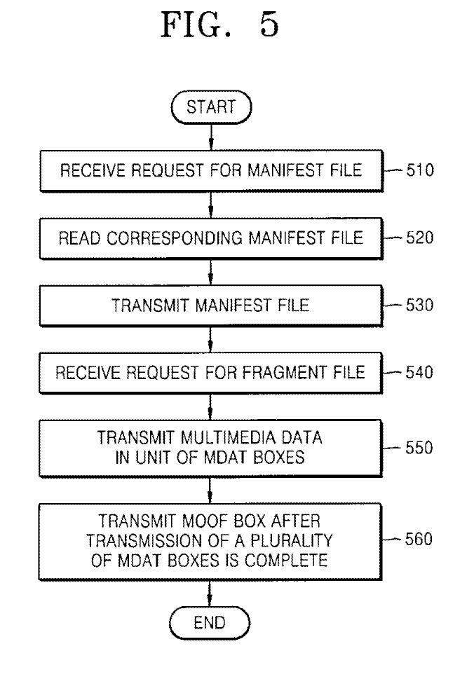

FIG. 5 is a flowchart of a method of servicing multimedia streaming, according to an exemplary embodiment.

First, a request for a manifest file corresponding to content information is received from a client 240 (operation 510).

Next, the manifest file that is requested by the client 240 is read (operation 520).

The read manifest file is transmitted to the client 240 (operation 530).

Next, a request for a fragment file corresponding to the manifest file is received from the client 240 (operation 540).

Afterward, multimedia data corresponding to the fragment file is received from a sender 210, and then the multimedia data is divided into units of mdat boxes and transmitted (operation 550). That is, as soon as the multimedia data is received from the sender 210, the multimedia data in units of mdat boxes is transmitted to the client 240.

Next, after the mdat boxes are completely transmitted, a moof box is transmitted to the client 240 (operation 560).

Thus, the server 220 may transmit a part of the multimedia data to the client 240 even before all of the multimedia data corresponding to one fragment is received, so that latency may be minimized.

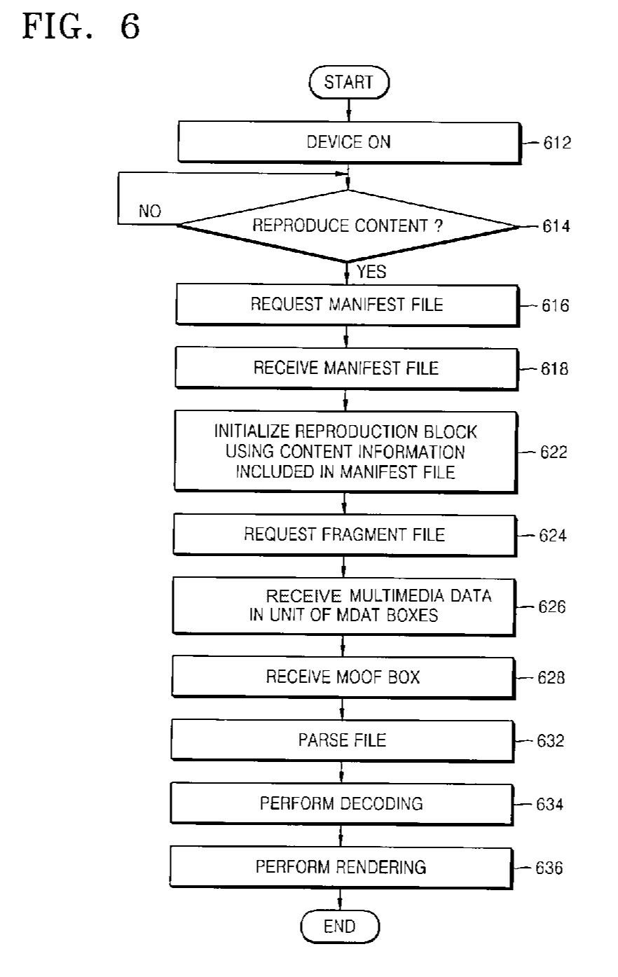

FIG. 6 is a flowchart of a multimedia streaming processing method performed by a client, according to another exemplary embodiment.

First, when a device is turned on (operation 612), a determination is made as to whether to reproduce content (operation 614).

In a case when content is to be reproduced, a manifest file corresponding to content information is requested from a server 220 (operation 616).

Afterward, the manifest file is received from the server 220 (operation 618).

Next, a reproduction block is initiated using various types of content information included in the manifest file (operation 622).

Afterward, a fragment file corresponding to the manifest file is requested from the server 220 (operation 624).

Next, multimedia data in units of mdat boxes is received from the server 220 (operation 626).

When a plurality of pieces of multimedia data are all received from the server 220, a moof box corresponding to metadata is received (operation 628).

Next, a fragment file formed of a plurality of mdat boxes and the moof box is parsed into image and audio data (operation 632).

The parsed image and audio data are decoded (operation 634).

Afterward, a rendering operation is performed so as to display an image on a screen (operation 636).

Exemplary embodiments may also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion.

While exemplary embodiments have been particularly shown and described, it will be understood by those of ordinary skill in the art that various changes in form and details may be made therein without departing from the spirit and scope of the present invention as defined by the following claims.

What is claimed is:

1. A method of constructing a multimedia streaming file format, the method comprising:
arranging a plurality of mdat boxes that store multimedia data, and a moof box that stores metadata related to the multimedia data stored in the plurality of mdat boxes; and
generating a fragment using the plurality of mdat boxes that store the multimedia data, and using the moof box that stores the metadata related to the multimedia data stored in the plurality of mdat boxes,
wherein the plurality of mdat boxes are positioned ahead of the moof box.

2. The method of claim 1, wherein a streaming file is formatted by adding a ftyp box and a moov box to at least one fragment, wherein the ftyp box describes a type of a content file and the moov box stores the metadata related to the multimedia data.

3. The method of claim 1, wherein a minimum unit of each of the plurality of mdat boxes is a frame unit.

4. The method of claim 1, wherein a minimum unit of each of the plurality of mdat boxes is a slice unit.

5. The method of claim 1, wherein a maximum unit of each of the plurality of mdat boxes is the multimedia data comprising audio/video data in the fragment.

6. The method of claim 1, wherein the moof box comprises a fragment size box.

7. A method of servicing multimedia streaming, the method comprising:
receiving a request for multimedia data in a unit of a fragment;
dividing and transmitting the multimedia data in units of a plurality of mdat boxes; and
after the dividing and transmitting the multimedia data in the units of the plurality of mdat boxes is complete, transmitting a moof box to a client, wherein the moof box comprises stored metadata related to the multimedia data stored in the plurality of mdat boxes.

8. The method of claim 7, wherein the fragment comprises:
the plurality of mdat boxes, and the moof box comprising the stored metadata related to the multimedia data stored in the plurality of mdat boxes, and
wherein the plurality of mdat boxes are positioned ahead of the moof box.

9. The method of claim 8, wherein a minimum unit of each of the plurality of mdat boxes is a frame unit or a slice unit.

10. The method of claim 8, wherein a maximum unit of each of the plurality of mdat boxes is the multimedia data comprising audio/video data in the fragment.

11. The method of claim 8, wherein a frame size box is added in the moof box and then the moof box is transmitted.

12. The method of claim 8, wherein a first mdat box from among the plurality of mdat boxes is accessed using the frame size box added in the moof box.

13. The method of claim 7, wherein the client reproduces the multimedia data by the unit of the fragment using the multimedia data that is received in the units of the plurality of mdat boxes, and the moof box that is received after the transmitting of the multimedia data is complete.

14. The method of claim 7, wherein the dividing and transmitting the multimedia data begins prior to receiving all multimedia data corresponding to the fragment.

15. An apparatus for servicing multimedia streaming, the apparatus comprising:
a file multiplexer that generates a fragment using a plurality of mdat boxes that divide and store multimedia data, and a moof box comprising stored metadata; and
a web server that divides and transmits the multimedia data in units of the plurality of mdat boxes when a request for a fragment file is received from a client, and that transmits the moof box comprising stored metadata when the transmitting of the multimedia data in the units of the plurality of mdat boxes is complete.

16. The apparatus of claim 15, wherein the web server begins to divide and transmit the multimedia data prior to receiving all multimedia data corresponding to the fragment file.

17. A computer readable recording medium having recorded thereon a program for executing the method of claim 7.
